(19) United States
(12) Patent Application Publication
(10) Pub. No.: US 2001/0002594 A1
(43) Pub. Date: Jun. 7, 2001

(54) Method and device for removing deposits from the ends of contacting needles of semiconductor test devices and use of a substrate for this purpose

(76) Inventor: Peter Binkhoff, Datteln (DE)

Correspondence Address: BIRCH, STEWART, KOLASCH AND BIRCH, LLP, P.O. Box 747, Falls Church, VA, 22040-0747, US

(21) Appl. No.: 09/730,396

(22) Filed: Dec. 6, 2000

(30) Foreign Application Priority Data
Dec. 6, 1999 (DE) 199 58 588.1

(51) Int. Cl. B08B 1/00

(52) U.S. Cl. 134/6; 15/104.002

(57) ABSTRACT

The device for removing bond pad material deposits adhering to the ends of contacting needles for contacting the bond pads of a die is provided with a substrate having an adhesive upper side adapted to be contacted by the ends of the contacting needles and being configured such that the adhesive force between the deposits and the upper side of the substrate is larger than the adhesive force between the deposits and the ends of the contacting needles.

### BACKGROUND OF THE INVENTION

The present invention relates to a method and a device for removing bond pad material deposits from the ends of contacting needles for contacting the bond pads of a semiconductor die. Further, the present invention relates to the use of a substrate having an upper side which generates an adhesive force for removing the bond pad material deposits from the ends of the contacting needles.

In different phases of the manufacture of semiconductor circuits it is necessary to test the electrical functions of the circuits. For example, the dies on the silicon wafer are electrically tested in that the bond pads of the dies are touched by the ends of the contacting needles. Good electrical contact requires a specific pressure force at which the contacting needles bear against the bond pads of the dies. When the contacting needles are removed from the bond pads after the test, bond pad material particles, generally AlSi and/or Al₂O₃ particles, remain on the ends of the contacting needles, From time to time the bond pad material thus accumulating must be removed from the ends of the contacting needles since otherwise said deposits may lead to damage irreversibly affecting the electrical functions of the bond pads. So far the contacting needle ends have been cleaned by moving them over a rough surface, e. g. abrasive paper, such that the deposits have been removed by abrasion. This process however also damages the ends of the contacting needles such that the life of said contacting needles is limited. The removal of bond pad material deposits by abrasion results in roughening of the ends of the contacting needles by the abrasive material, which may also lead to damage of the bond pads when they are subsequently contacted.

JP-A-10339766 discloses a method where the points of the contacting needles are stuck from time to time into a rubber material for the purpose of cleaning the needle points. Particles adhering to the points of the contacting needles are pressed into the rubber material and are retained there when the contacting needles are withdrawn from the rubber material. This is a purely mechanical cleaning process which protects the contacting needle points. There is however the danger that by sticking the contacting needles into the rubber material, rubber material particles may adhere to the needle points, which may affect the functioning of said contacting needles.

### SUMMARY OF THE INVENTION

It is an object of the present invention to provide a method, a device and use of a substrate for removing bond pad deposits from the ends of contacting needles such that the life of the contacting needles is increased and the danger of damage during subsequent contacting of the bond pads is reduced without the electrical properties of the contacting needles being affected.

According to the invention a device is provided which comprises:

a substrate having an adhesive upper side adapted to be contacted by the ends of the contacting needles and being configured such that the adhesive force between the deposits and the upper sidle of the substrate is larger than the adhesive force between the deposits and the ends of the contacting needles.

Further the present invention provides a method where:

the ends of the contacting needles carrying deposits contact the upper side of a substrate which exerts an adhesive force on the deposits with the adhesive force of the upper side being larger than the adhesive force between the deposits and the ends of the contacting needles.

Finally the present invention provides use of a substrate having an upper side generating an adhesive force for removing, by touching the upper side of the substrate with the ends of the contacting needles, deposits adhering by adhesive force to the ends of contacting needles for contacting the bond pads of semiconductor dies.

According to the invention it is provided to remove deposits on the contacting needle ends by bringing said ends in contact with the upper side of the substrate with the deposits remaining on the upper side of the substrate due to the adhesive force. The adhesive force between the bond material deposits and the upper side of the substrate is larger than the adhesive force between the deposits and the contacting needle ends. Adhesion is a physical process where two elements (in this case the metal particles on the one hand and the polymer substrate having in particular long-chain molecules on the other hand) adhere to one another due to electrostatic attraction. For this purpose the substrate or at least its upper side comprises dipoles which can be changed and aligned and which provide the required attractive force. The dipoles either align themselves on the basis of the electrical field of the (charged) particles or by charge carrier diffusion (e.g. in the case of unpolarized (metal surfaces of the) particles) via the interface between the particles and the substrate or are aligned by corresponding pretreatment (e.g. by friction, i.e. triboelectrically) such that their poles which are Opposite to the charge of the particles face said particles.

Removal of the deposit particles from the contacting needle ends by bringing the needle ends in touch with the upper side of the substrate protects the ends of the contacting needles to a higher degree than state-of-the-art removal of deposits with the aid of abrasive material along which the ends of the contacting needles are moved. This prolongs the life of the contacting needles. Further, due the fact that the contacting needles are not subject to wear the cleaning or removing processes, i.e. contacting the substrate with the contacting needles, can be performed more frequently than the state-of-the-art cleaning processes. This, in turn, has a positive effect when the contacting needles contact the bond pads of the dies since thanks to the more frequently performed cleaning processes fewer deposit particles can accumulate on the ends of the contacting needles, which protects the bond pads of the dies to be tested

Generally the hardness of the material on the upper side of the substrate is of no importance for the cleaning process as long as the adhesive force ratio is as described above. However tests have shown that it is advantageous if the upper side of the substrate is of compliant and in particular elastic configuration. When the contacting needles are placed onto the elastic upper side of the substrate, the substrate is locally deformed in the form of a funnel-shaped deepened portion without the ends of the contacting needles penetrating the upper side of the substrate. Thus the contacting needle ends touch the upper side of the substrate in a larger (surface) area so that more deposit particles adhere to the upper side of the substrate. Materials providing resilient properties, such as elastomer materials, are suitable as substrate. It is particularly appropriate if the upper side of the substrate comprises an artificial or natural caoutchouc material.

Particular good test results are attained when a material based on polysiloxane is used on the upper side of the substrate or as the complete substrate. The film sold under the tradename “GEL-PAK”, PF-40/17-X8, by GEL Elastomere Technology and Vichem Corporartion, Sunnyvale, has proved to be a suitable material. Said material is used in the semiconductor sector e.g. for reducing the thickness of silicon wafers on one side. The film is applied to the untreated lower side of the silicon wafer to prevent damage when the upper side is polished. Further, the aforementioned film is used as transporting means of dies.

Surprisingly, application of the theory according to the invention showed that it is possible by selection of suitable material pairing of substrate upper side and particle deposits alone to remove, by electrostatic adhesion, said particle deposits from the ends of the contacting needles. This process protects the contacting needle ends to an extremely high degree such that their life is prolonged. In particular no residues of the substrate (cleansing agent) remain on the contacting needles since they do not penetrate the substrate but merely contact the substrate, with the upper side of the substrate possibly being impressed.

The substrate may either be completely made of the same material as its upper side or comprise on its upper side a coating of a material which produces the aforementioned results due to (electrostatic) adhesion. The adhesive force between this coating material and the substrate should be larger than the adhesive force between the coating material and the deposit particles since otherwise there is the danger that the coating material is separated from the substrate when the contacting needles are removed after having contacted the coating material.

### BRIEF DESCRIPTION OF THE DRAWINGS

Hereunder the concept according to the invention is explained in detail with reference to the drawings in which:

FIG. 1 shows a side view of the end of a contacting needle with bond material particles adhering to said contacting needle which is disposed above an adhesive cleaning substrate prior to the substrate being contacted, wherein merely the substrate upper boundary layer facing the needle is shown,

FIG. 2 shows the contacting needle with its end touching the upper side of the substrate, the contacting needle end locally deforming the substrate, and

FIG. 3 shows the contacting needle above the substrate when the former has been removed from the substrate.

### DESCRIPTION OF THE PREFERRED EMBODIMENT

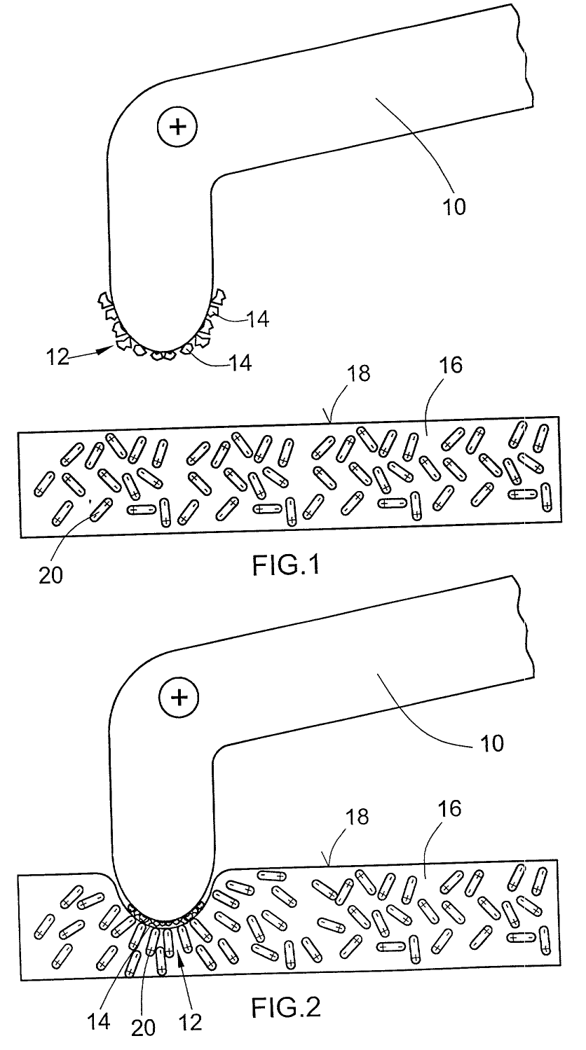

FIG. 1 shows a side view of a contacting needle 10 carrying bond pad material particles 14 on its rounded end 12. The end 12 of the contacting needle 10 is disposed above a substrate 16 having an upper side 18. The substrate 16 is made of a material based on polysiloxane, in particular the material sold under the trade name “GEL-PAK”, PF-40/17-X8, by Vichem Corporation, Sunnyvale. This material comprises dipoles 20 which can be changed and aligned.

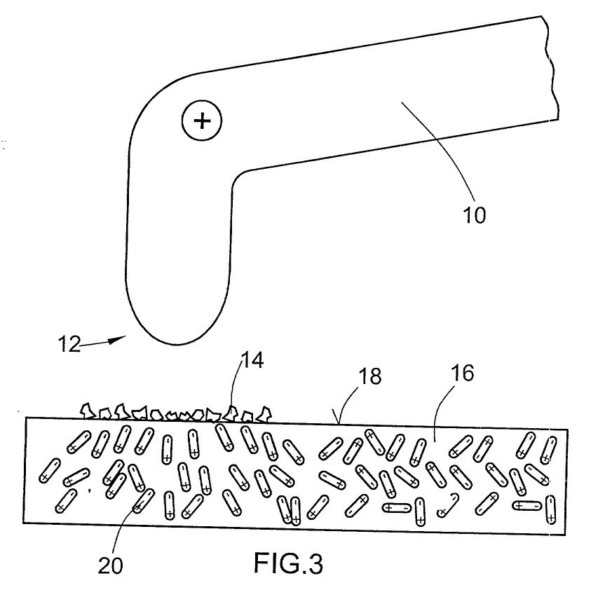

Cleaning of the end 12 of the contacting needle 10 is carried out by said end 12 contacting the upper side 18 of the substrate 16 with the particles 14 remaining on the upper side 18 due to (electrostatic) adhesion. The particles 14 are substantially unipolar. Due to von-der-Waals interactions and charge carrier diffusions those dipoles 20 of the substrate 16 will align themselves which are in the immediate vicinity of that area of the upper side 18 in which the substrate 16 is touched by the end 12 of the contacting needle 10. On the basis of thermodynamical considerations it can be calculated that strong chemical potentials are built up at the interface. Such interface contacts lead to an increase in the free energy of the multiphase system. Under the effect of said potentials electrones begin to migrate via the interface from one phase to the other. This migration is continued until the chemical potential at the phase interface is energetically balanced. However this does not result in a potential-free equilibrium but on the contrary in the build-up of an electrical double layer. This situation is illustrated in FIGS. 2 and 3 which, like the other figures, show the upper interface area of the substrate, and FIG. 2 shows that the substrate 16 is depressed towards the inside at the place where the end 12 of the contacting needle 10 contacts the substrate 16.

When, proceeding from the situation shown in FIG. 2, the contacting needle 10 is removed from the upper side 18 of the substrate 16, the particles 14 remain on the upper side 18 of the substrate 16 due to the electrostatic attractive forces (adhesion). In other words, the electrostatic adhesive forces between the upper side 18 of the substrate 16 and the particles 14 are larger than the force at which the particles 14 adhere to the end 12 of the contacting needle 10.

Although the preferred embodiment of the invention has been specifically illustrated and described herein, it is to be understood that minor variations may be made in the device without departing from the spirit and scope of the invention, as defined in the appended claims.

What is claimed is:

1. Device for removing bond pad material deposits (14) adhering to the ends (12) of contacting needles (10) for contacting the bond pads of a die, the device comprising:
a substrate (16) having an adhesive upper side (18) adapted to be contacted by the ends (12) of the contacting needles (10) and being configured such that the adhesive force between the deposits (14) and the upper side (18) of the substrate (16) is larger than the adhesive force between the deposits (14) and the ends (12) of the contacting needles (10).

2. Device according to claim 1, wherein the upper side (18) of the substrate (16) is of compliant, in particular elastic configuration.

3. Device according to claim 1, wherein the upper side (18) of the substrate (16) comprises a polymer and/or elastomer material or both.

4. Device according to claim 1, wherein the upper side (18) of the substrate (16) comprises caoutchouc.

5. Device according to claim 1, wherein the upper side (18) of the substrate (16) comprises a material based on polysiloxane.

6. Device according to claim 1, wherein the upper side (18) of the substrate (16) is an upper side coating and the adhesion between the coating and the substrate (16) is larger than the adhesion between the deposits (14) on the ends (12) of the contacting needles (10) and the coating.

7. Method for removing bond pad material deposits (14) adhering to the ends (12) of contacting needles (10) for contacting the bond pads of a die, wherein
the ends (12) of the contacting needles (10) carrying the deposits (14) are brought in contact with an upper side (18) of a substrate (16) which exerts an adhesive force on the deposits (14), with the adhesive force of the upper side (18) of the substrate (16) being larger than the adhesive force between the deposits (14) and the ends (12) of the contacting needles (10).

8. Use of a substrate (16) having an upper side (18) which generates an adhesive force for removing deposits (14) adhering at a low adhesive force to the ends (12) of contacting needles (10) by the ends (12) of the contacting needles (10) touching the upper side (18) of the substrate (16).

9. Method according to claim 7 or use according to claim 8 employing the substrate (16) of a device according to claim 1.
